(19) United States
(12) Patent Application Publication
(10) Pub. No.: US 2008/0026891 A1
(43) Pub. Date: Jan. 31, 2008

(54) Bicycle rear derailleur

(75) Inventor: Shinya Oseto, Sakai (JP)

Correspondence Address: GLOBAL IP COUNSELORS, LLP, 1233 20TH STREET, NW, SUITE 700, WASHINGTON, DC, 20036-2680, US

(73) Assignee: Shimano Inc., Sakai (JP)

(21) Appl. No.: 11/495,542

(22) Filed: Jul. 31, 2006

(51) Int. Cl. F16H 61/00; F16H 9/00

(52) U.S. Cl. 474/82

(57) ABSTRACT

A bicycle rear derailleur includes a base member, a movable member, a torsion spring, a linkage assembly and a damping member. The base member is configured to be attached to a bicycle frame. The movable member includes a support portion and a chain guide coupled to the support portion. The torsion spring is disposed about a pivot member of at least one of the base member and the movable member. The linkage assembly is coupled between the base member and the support portion to move the chain guide between a retracted position and an extended position. The damping member is at least partially disposed between an adjacent pair of coils of the torsion spring.

### BACKGROUND OF THE INVENTION

1. Field of the Invention

This invention generally relates to a bicycle rear derailleur. More specifically, the present invention relates to a bicycle rear derailleur having a torsion spring a damping member at least partially disposed between an adjacent pair of coils of the torsion spring.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle. One component that has been extensively redesigned is the bicycle rear derailleur.

Typically, a rear derailleur has a base member and a movable member with a chain guide movably coupled to the base member via a linkage assembly. The base member is typically coupled to the rear triangle of the bicycle frame using a bolt for limited rotation about the bolt. The chain guide is configured to move the chain laterally over a plurality of rear sprockets. The chain guide is typically coupled to the movable member using shaft for limited rotation relative to the movable member. The linkage assembly typically includes a pair of pivotal links pivotally coupled to both the base member and the movable member using pivot pins. A spring typically biases the chain guide to an innermost or outermost position relative to the rear sprockets. A bowden-type control cable with an outer sheath and an inner wire is typically coupled between the rear derailleur and a conventional shift control device. Thus, the chain guide can be moved laterally by moving the linkage assembly via the inner wire. Pulling the inner wire moves the chain guide against the biasing force of the spring, while releasing the inner wire causes the chain guide to move due to the biasing force of the spring.

While these typical rear derailleurs usually work well, there are drawbacks with the typical rear derailleur designs. In particular, pivot pins (members) are typically attached using a threaded connection, a press fit and/or retaining clip(s) mounted on the end(s) of the pivot pins. While this works relatively well, it can be inconvenient and/or cumbersome to install and remove (if needed) such pivot pins. In particular, some pivot pins utilize very small parts, which are difficult to handle and which may be lost during assembly and/or disassembly. Additionally, with prior art derailleurs, the chain guide may swing slightly due to vibrations, especially when traveling over uneven terrain. Unintended swinging of the chain guide can lead to chain bounce, which can adversely affect shifting performance, especially when traveling over uneven terrain.

In view of the above, it will be apparent to those skilled in the art from this disclosure that there exists a need for an improved bicycle rear derailleur. This invention addresses this need in the art as well as other needs, which will become apparent to those skilled in the art from this disclosure.

### SUMMARY OF THE INVENTION

One object of the present invention is to provide a bicycle rear derailleur that moves a chain guide between a plurality of lateral shift positions in a smooth and reliable manner.

Another object of the present invention is to provide a bicycle rear derailleur, which restricts chain guide swing due to vibration, and thus, reduces chain bounce.

Another object of the present invention is to provide a bicycle rear derailleur, which is relatively simple and inexpensive to manufacture and assemble.

The foregoing objects can basically be attained by providing a bicycle rear derailleur comprising a base member, a movable member, a torsion spring, a linkage assembly and a damping member. The base member is configured to be attached to a bicycle frame. The movable member includes a support portion and a chain guide. The torsion spring is disposed about a pivot member of at least one of the base member and the movable member. The linkage assembly is coupled between the base member and the support portion to move the chain guide between a retracted position and an extended position. The damping member is at least partially disposed between an adjacent pair of coils of the torsion spring.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is an outside elevational view of a portion of a bicycle having a rear derailleur mounted thereto in accordance with a first embodiment of the present invention;

FIG. 2 is an enlarged, rear end elevational view of the rear derailleur illustrated in FIG. 1 with the chain guide in a retracted position, with an extended position of the chain guide shown in phantom lines for the purpose of illustration;

FIG. 3 is an enlarged, front end elevational view of the rear derailleur illustrated in FIG. 1;

FIG. 4 is a top plan view of the rear derailleur illustrated in FIGS. 2-3;

FIG. 5 is an enlarged, partial cross-sectional view of the base member and axle assembly of the rear derailleur illustrated in FIGS. 1-4, as seen along section line 5-5 of FIG. 4;

FIG. 6 is an enlarged, partial cross-sectional view of the base member and pivot pin assembly of the rear derailleur illustrated in FIGS. 1-4, as seen along section line 6-6 of FIG. 2;

FIG. 7 is an enlarged, partial cross-sectional view of the movable member and axle assembly of the rear derailleur illustrated in FIGS. 1-4, as seen along section line 7-7 of FIG. 4;

FIG. 8 is an enlarged, perspective view of the torsion spring and damper member of the movable member illustrated in FIG. 7;

FIG. 9 is an end elevational view of the torsion spring and damper member illustrated in FIG. 8;

FIG. 10 is an enlarged, perspective view of the pivot pin and optional locking member illustrated in FIG. 6;

FIG. 11 is a perspective view of the axle member illustrated in FIG. 7 on a reduced scale;

FIG. 12 is an enlarged, partial cross-sectional view of the movable member and axle assembly of the rear derailleur illustrated in FIGS. 1-4, as seen along section line 7-7 of FIG. 4, but with the damper member of the first embodiment replaced with a modified damper member in accordance with a second embodiment of the present invention;

FIG. 13 is an enlarged, perspective view of the torsion spring and damper member of the movable member illustrated in FIG. 12; and

FIG. 14 is an enlarged, perspective view of the damper member of the movable member illustrated in FIG. 12.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

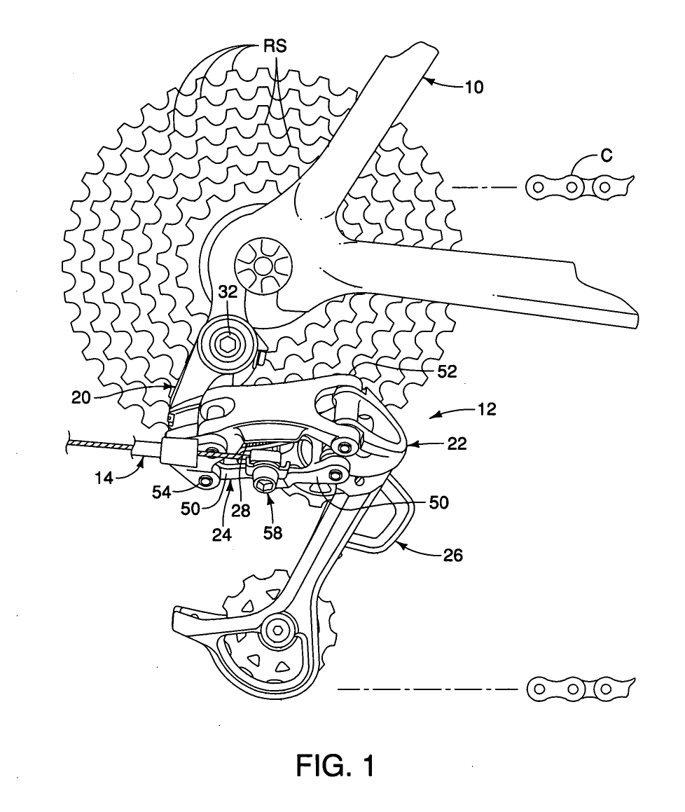

Referring initially to FIG. 1, a rear portion of a bicycle frame 10 is illustrated having a rear derailleur 12 mounted thereto in accordance with a preferred embodiment of the present invention. The rear fork or triangle of the bicycle frame 10 has a rear gear assembly (cassette) having multiple rear gears or sprockets RS rotatably coupled thereto via the rear hub (not shown). A chain C is received on the rear sprockets RS and is operatively coupled to a set of front gears or sprockets (not shown) in a conventional manner for transmitting the desired rotational torque to the rear wheel of the bicycle in a conventional manner. The rear derailleur 12 is coupled to a rear derailleur shifting mechanism (not shown) via a rear shift wire or shift cable 14 in a conventional manner. More specifically, the rear derailleur 12 is illustrated as low-normal type that is designed to be normally biased inwardly such that the chain C is normally positioned on the innermost (largest) gear or sprocket RS. Thus, when the rider actuates the rear derailleur shifting mechanism to pull the cable 14, the rear derailleur 12 moves the chain C outwardly to engage the next smaller gear. On the other hand, when the rider actuates the rear derailleur shifting mechanism (not shown) to release the cable 14, the rear derailleur 12 moves the chain C inwardly to engage the next larger gear. However, it will be apparent to those skilled in the art from this disclosure that the rear derailleur 12 could be a top-normal type if needed and/or desired.

The rear derailleur 12 preferably includes a plurality of pivot pins 54 and/or a second pivot axle 62 in accordance with the present invention, as explained below. Optionally, the rear derailleur 12 may also include a first pivot axle 32 in accordance with the present invention as also explained below. Additionally, the rear derailleur 12 preferably includes a damping member D configured and arranged to restrict chain bounce, as explained below.

Referring now to FIGS. 1-7, the rear derailleur 12 basically includes a base member 20, a movable member 22, a linkage assembly 24, a chain guide 26, a main biasing member 28 and the damping member D. Basically, the base member 20 is fixedly coupled to the frame 10 for limited pivotal movement, while the movable member 22 is coupled to the base member 20 via the linkage assembly 24. The chain guide 26 is coupled to the movable member 22 for limited pivotal movement. In the illustrated embodiment, the biasing member 28 is coupled between the base member 20 and the movable member 22 of the rear derailleur 12 such that the chain guide 26 is normally biased laterally inwardly toward the largest rear sprocket RS, as mentioned above. The damping member D is disposed on the movable member 22 to restrict swing of the chain guide 26.

The basic operation of the rear derailleur 12 is well known in the prior art. Thus, the rear derailleur 12 will not be discussed or illustrated in detail herein, except as related to the present invention. In other words, this disclosure will focus mainly on the pivotal connections (e.g., the pivot pins 54, the second pivot axle 62 and optionally the first pivot axle 32) and the damping member D of the rear derailleur 12 of the present invention. While a mechanical (i.e., cable actuated) derailleur 12 is illustrated, it will be apparent to those skilled in the art from this disclosure that the present invention can be employed in other types of derailleurs such as pneumatic derailleurs, motorized/electrical derailleurs or electromechanical derailleurs.

Referring now to FIGS. 1-5, the base member 20 basically includes a first housing 30, the first horizontal pivot shaft or pivot axle 32 (first pivot member), a fixed element (stopper plate) 34 and a first biasing member 36. The housing 30 is pivotally supported on the first axle 32. The fixed element (stopper plate) 34 is secured to the first axle 32 and to the bicycle frame 10 to control the amount of pivotal movement of the housing 30 relative to the bicycle frame 10. The first biasing member 36 is preferably a coiled torsion spring that is coaxially mounted about the first axle 32. The first spring 36 has a one end coupled to the housing 30 and the opposite end coupled to the stopper plate 34 to apply a rotational biasing force to the housing 30 in a conventional manner.

A U-shaped retainer clip 37 is mounted adjacent a threaded end of the first axle 32 to retain the structure together prior to mounting to the bicycle frame 10. The threaded end of the first axle 32 is threadedly attached to the bicycle frame 10 as seen in FIG. 8. Thus, in this embodiment, the base member 20 is illustrated as being directly threadedly coupled to the frame 10 via the first axle 32. However, it will be apparent to those skilled in the art from this disclosure that a removable derailleur hanger or hanging plate (not shown) may be utilized to connect the base member 20 of the rear derailleur 12 to the frame 10. These types of derailleur hangers (not shown) are well known in the art, and thus, will not be discussed or illustrated herein. Moreover, it will be apparent to those skilled in the art from this disclosure that base member 20 can be modified to utilize a modified first pivot axle like the second pivot axle 62 in accordance with the present invention, if needed and/or desired.

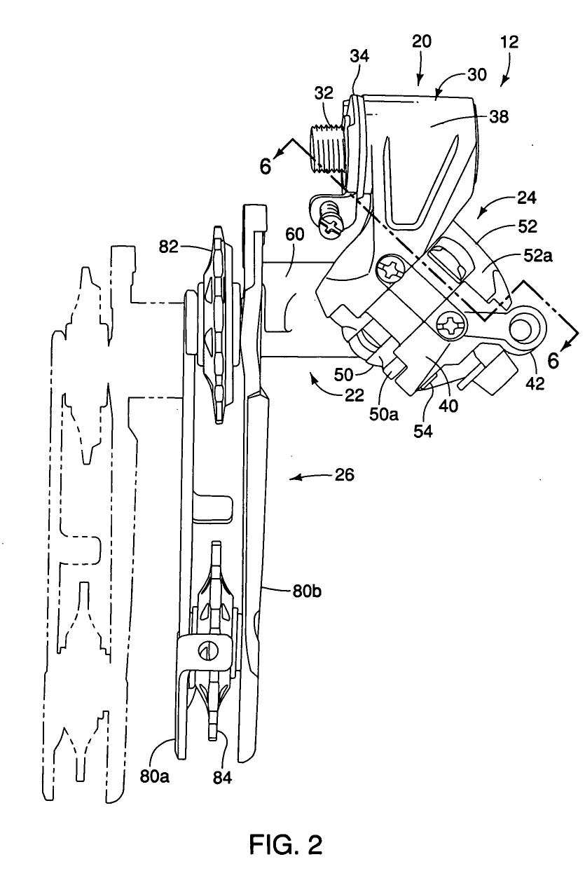

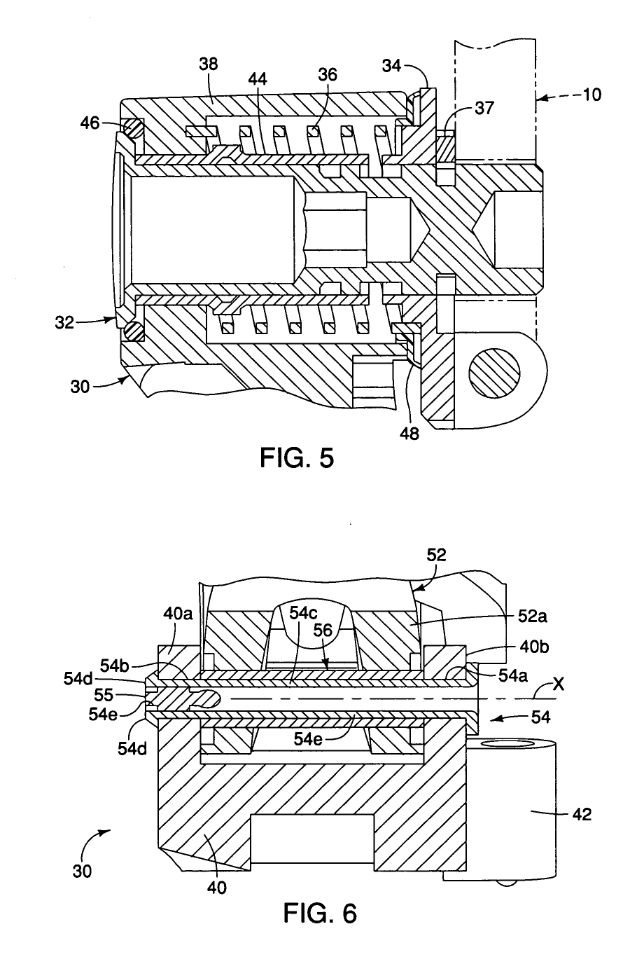

As seen in FIGS. 2-5, the housing 30 basically includes a main mounting portion 38, a first support portion 40 and a cable guide element 42. Preferably, the main mounting portion 38, the first support portion 40 and the cable guide element 42 are integrally formed together as a one-piece, unitary member from a lightweight, rigid material such as a metallic material or any other material that is well known in the bicycle art. The main mounting portion 38 is pivotally supported on the first axle 32 for limited pivotal movement. Specifically, as seen in FIG. 5, the main mounting portion 38 has a stepped bore with the first axle 32 received therein. The first support portion 40 is configured and arranged to have the linkage assembly 24 pivotally coupled thereto in accordance with the present invention. The cable guide element 42 includes a stepped bore configured to receive the outer casing of the rear derailleur cable 14 partially therein and the inner wire of the rear derailleur cable 14 therethrough in a conventional manner.

As best seen in FIG. 5, the first axle 32 (first pivot member) is a bolt that is threadedly coupled to the bicycle frame 10 such that the first axle 32 forms a fixed pivot axle. The first axle 32 includes a tubular sleeve member 44 pivotally mounted thereon. The sleeve member 44 is arranged between the first axle 32 and the main mounting portion 38 to pivotally support the housing 30 on the first axle 32 in a smooth manner. An O-ring 46 that is constructed of a low-friction, slightly resilient material is arranged between the free end of the first axle 32 and the housing 30. Similarly, a seal ring 48 that is constructed of a low-friction, slightly resilient material is arranged at the opposite end of the first axle between the stopper plate 34 and the housing 30. The rings 46 and 48 are configured and arranged to seal opposite ends of the stepped bore of the main mounting portion 38.

Referring now to FIGS. 1-4 and 6, the linkage assembly 24 and the pivotal connections between the linkage assembly 24 and the base member 20 and the movable member 22 will now be explained in more detail. The linkage assembly 24 basically includes inner and outer links 50 and 52. The inner and outer links 50 and 52 are pivotally coupled to the housing 30 of the base member 20 and pivotally coupled to the movable member 22. Specifically, four pivot pins 54 in accordance with the present invention and four pivot sleeves 56 are used to pivotally couple the ends of the inner and outer links 50 and 52 to the base member 20 and the movable member 22 in accordance with the present invention. Of course, it will be apparent to those skilled in the art from this disclosure that the pivot sleeves 56 may be eliminated if needed and/or desired. With such an arrangement, it will be apparent to those skilled in the art from this disclosure that the size(s) of at least some of the holes in the base member 20, the movable member 22 and/or linkage assembly 24 would need to be changed.

In any case, the inner link 50 includes a first inner link end 50a and a second inner link end 50b, while the outer link 52 includes a first outer link end 52a and second outer link end 52b. The first inner and outer link ends 50a and 52a are pivotally coupled to the first support portion 40 of the base member 20 using two of the pivot pins 54 and two of the pivot sleeves 56, while the second inner and outer link ends 50b and 52b are pivotally coupled to the movable member 22 using two of the pivot pins 54 and two of the pivot sleeves 56 in the illustrated embodiment. The inner link 50 is provided with a cable-fixing structure 58 for attaching the inner wire of the shift cable 14 thereto in a conventional manner.

The pivotal connections between the inner and outer links 50 and 52, the base member 20 and the movable member 22 are substantially identical. Accordingly, only one of these pivotal connections (i.e., between the outer link 54 and the base member 20) will be discussed and illustrated in detail herein for the sake of brevity. However, it will be apparent to those skilled in the art from this disclosure that descriptions and illustrations of this single pivotal connection also apply to the other pivotal connections between the inner and outer links 50 and 52, the base member 20 and the movable member 22, except as explained and illustrated herein.

The first outer link end 52a is pivotally coupled between a pair of flanges 40a and 40b of the first support portion 40 using one of the pivot pins 54 (third pivot members) and one of the pivot sleeves 56, as best seen in FIG. 6. Specifically, the outer link 52 has the pivot sleeve 56 non-movably mounted thereto, while the pivot pin 54 is mounted to the first support portion 40. The pivot sleeve 56 is pivotally mounted on the pivot pin 54 such that the outer link 52 is pivotally coupled to the base member. More specifically, the flange 40a of the first support portion 40 is an inner/upper flange, while the flange 40b of the first support portion 40 is an outer/lower flange spaced from the flange 40a. A linkage receiving area is formed between the flanges 40a and 40b.

Referring now to FIGS. 1-4, 6 and 10, each pivot pin 54 includes a first abutment end 54a, a second resilient fastening end 54b and a shaft portion 54c extending between the first and second ends 54a and 54b, as best seen in FIG. 10. The first abutment end 54a, the second resilient fastening end 54b and the shaft portion 54c are preferably integrally formed together as a one-piece, unitary member from a lightweight, rigid yet elastic material such as a metallic material. In any case, the resilient fastening end 54b is preferably permanently fixedly attached to the shaft portion 54c. The first abutment end 54a has an enlarged head arranged at the end of a reduced diameter section, which contacts the flange 40b.

The second resilient fastening end 54b has a pair of resilient fastening fingers (elements) 54d with a pair of longitudinal slots 54e arranged therebetween. The resilient fastening end 54b is configured to releasably attach the pivot pin 54 to the linkage assembly 24 via a snap fit. In the illustrated embodiment, the pivot pins 54 are hollow. The shaft portion 54c includes a pivot axis X, and the resilient fastening fingers (elements) 54d and the slots 54e extend in a direction substantially parallel to the pivot axis X. Thus, the fastening fingers 54d deflect toward the pivot axis X during insertion of the pivot pin 54.

Each of the resilient fastening fingers 54d has a protruding portion (abutment) that extends radially outwardly from a reduced diameter section to selectively retain the pivot pin 54. The resilient fastening fingers 54d are deflected radially inwardly toward each other during insertion of the pivot pin 54, but returns to the position illustrated in FIGS. 6 and 10 upon being fully inserted as shown in FIG. 6 such that the protrusions of the fastening fingers 54d contact the flange 40a. Thus, the resilient fastening end 54b is configured and arranged to be deflected inwardly from a retaining position to a release position during insertion and back to the retaining position upon reaching a fully inserted position to prevent removal of the pivot pin 54. In other words, the resilient fastening end 54b is configured and arranged to releaseably retain the pivot pin 54 with the linkage assembly 24.

The reduced diameter section of the resilient fastening end 54b corresponds to the normal outer diameter (i.e., the diameter of the pivot pin 54 along its majority) of the pivot pin 54 and the reduced diameter section of the abutment end 54a. The diameter of the pivot pin 54 along its majority (i.e., the reduced diameter) is configured and arranged such that the pivot pin 54 freely rotatably supports the link member 52 relative to the flanges 40a and 40b in the fully inserted position. The shaft portion 54c is pivotally received within the pivot sleeve 56 and is contiguously connected to the reduced diameter sections of the first and second ends 54a and 54b, which are disposed within through holes formed in the flanges 40b and 40a, respectively, in the fully inserted (installed) position.

Optionally, the pivot pins 54 may each include a locking member 55 mounted within the resilient fastening end 54b after the pivot pin 54 is installed to prevent inward deflection of the resilient fastening fingers 54d upon reaching the fully inserted position to prevent removal of the pivot pin 54 upon reaching the fully inserted position. In other words, the locking member 55 can be used to more securely attach the pivot pin 54 to the rear derailleur, as best seen in FIGS. 6 and 10. The locking member 55 is configured and arranged to be press fitted and/or snap fitted within the hollow interior of the resilient fastening end 54b and within the slots 54e. In particular, the slots 54e have a linear section and a bulbous inner section, while the locking member 55 has a mating shape so as to be retained within the resilient fastening end 54b. The pivot pin 54 cannot be removed from the rear derailleur 12 when the optional locking member 55 is installed.

The pivot sleeve 56 is a tubular member with a circular cross-sectional shape. The pivot sleeve 56 is preferably a separate member from the base member 20 and the outer link 52. The pivot sleeve 56 is fixed to the outer link 52 via a press fit or the like. Specifically, the pivot sleeve 56 is preferably frictionally fixed within a pair of through holes formed in free ends of the outer link 52, as best seen in FIG. 6. The pivot sleeve 56 is configured and arranged to extend between the flanges 40a and 40b to pivotally support the pivot pin 54 therein along the entire shaft portion 54c. As mentioned above, it will be apparent to those skilled in the art from this disclosure that the pivot sleeve 56 can be eliminated if needed and/or desired.

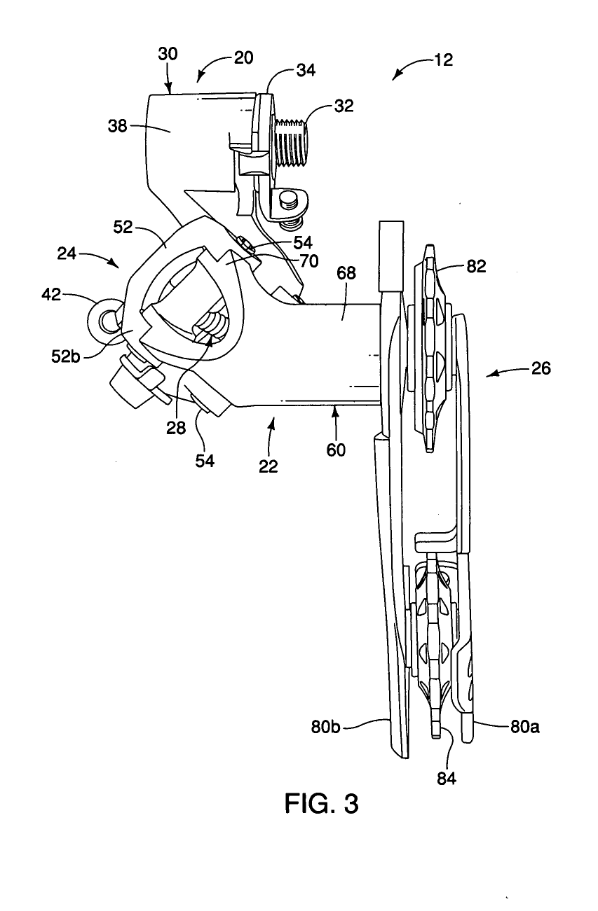

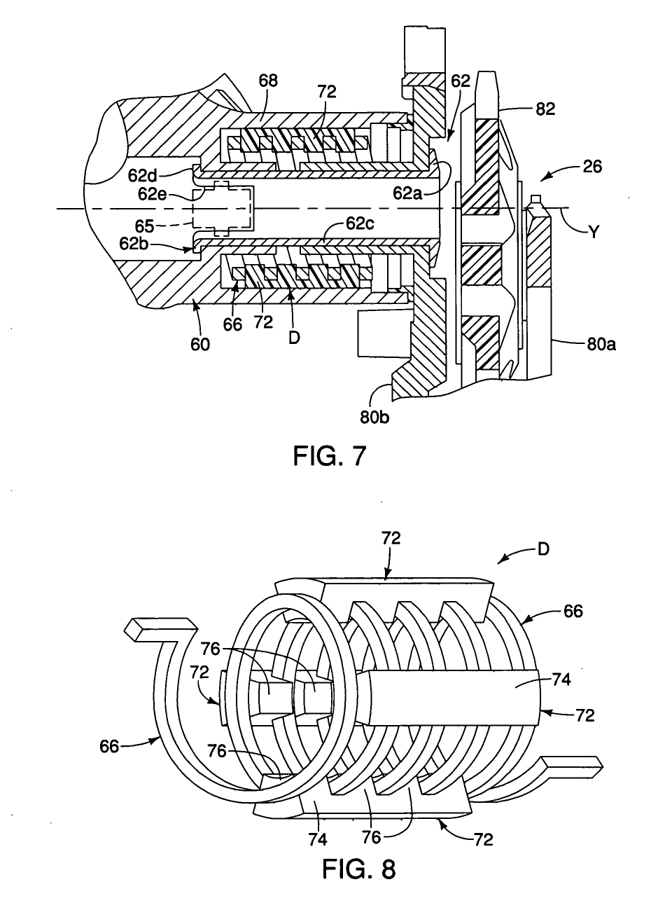

The first inner link end 50a is pivotally coupled between the flanges 40a and 40b using one of the pivot pins 54 and one of the pivot sleeves 56 in a manner identical to the outer link 52, as best understood from FIGS. 3 and 7. The only difference is the shape of the inner link 50 as compared to the outer link 52. Accordingly, the pivotal connection between the first inner link end 50a and the first support portion 40 will not be discussed and/or illustrated in further detail herein. Rather, it will be apparent to those skilled in the art from this disclosure that the descriptions and illustrations of the pivotal connection between the first outer link end 52a and the first support portion 40 also apply to the pivotal connection between the first inner link end 50a and the first support portion 40, except as explained and illustrated herein.

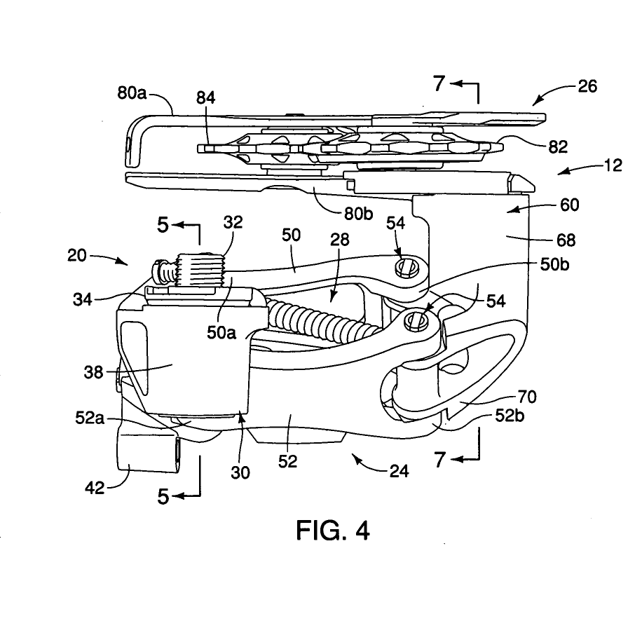

The second inner and outer link ends 50b and 52b are pivotally coupled to the movable member 22 in a manner identical to the first inner and outer link ends 50a and 50b, except that the arrangement between the movable member 22 relative to the inner and outer links 50 and 52 is reversed as compared to the arrangement between the base member 20 and the inner and outer links 50 and 52, as seen in FIG. 4. In other words, the second inner and outer link ends 50b and 52b have the pivot pins 54 attached thereto, while the movable member 22 has the pivot sleeves 56 fixed thereto. This arrangement will be discussed in more detail below.

Referring to FIGS. 1-4, 7 and 11, the movable member 22 and the connections of the linkage assembly 24 and the chain guide 26 to the movable member 22 will now be explained in more detail. The movable member 22 basically includes basically includes a second housing 60, the second horizontal pivot shaft or pivot axle 62 (second pivot member), and a second biasing member 66. The housing 60 is fixedly attached to the second axle 62 in order to pivotally support the chain guide 26 on the second axle 62. The second biasing member 66 is preferably a coiled torsion spring that is coaxially mounted about the second axle 62. The second spring 66 has one end coupled to the housing 60 and the opposite end coupled to the chain guide 26 to apply a rotational biasing force to the housing 60 in a conventional manner. The second axle 62 is similar to the pivot pins 54, except for its size, as best understood from FIGS. 7 and 11.

Specifically, the second pivot axle 62 (second pivot member) basically includes a first abutment end 62a, a second resilient fastening end 62b and a pivot shaft portion 62c extending between the first and second ends 62a and 62b, as best seen in FIG. 7. The first abutment end 62a, the second resilient fastening end 62b and the shaft portion 62c are preferably integrally formed together as a one-piece, unitary member from a lightweight, rigid yet elastic material such as a metallic material. In any case, the resilient fastening end 62b is preferably permanently fixedly attached to the shaft portion 62c. The first abutment end 62a has an enlarged head arranged at the end of a reduced diameter section, which contacts an abutment flange of the second housing 60.

The second resilient fastening end 62b has a pair of resilient fastening fingers (elements) 62d with a pair of longitudinal slots 62e arranged therebetween. The resilient fastening end 62b is configured to releasably attach the second pivot axle 62 to the movable member 22 via a snap fit to releaseably attach the chain guide 26 thereto. In the illustrated embodiment, the pivot axle 62 is hollow. The shaft portion 62c includes a pivot axis Y, and the resilient fastening fingers (elements) 62d and the slots 62e extend in a direction substantially parallel to the pivot axis Y. Thus, the fastening fingers 62d deflect toward the pivot axis Y during insertion of the pivot pin 54.

Each of the resilient fastening fingers 62d has a protruding portion (abutment) that extends radially outwardly from a reduced diameter section. The resilient fastening fingers 62d are deflected radially inwardly toward each other during insertion of the pivot axle 62, but returns to the position illustrated in FIGS. 7 and 11 upon being fully inserted as shown in FIG. 6 such that the protrusions of the fastening fingers 62d contact the second housing 60. Thus, the resilient fastening end 62b is configured and arranged to be deflected inwardly from a retaining position to a release position during insertion and back to the retaining position upon reaching a fully inserted position to prevent removal of the pivot axle 62. In other words, the resilient fastening end 62b is configured and arranged to releaseably retain the pivot axle 62 with the movable member 22.

The reduced diameter section of the resilient fastening end 62b corresponds to the normal outer diameter (i.e., the diameter of the pivot axle 62 along its majority) of the pivot axle 62 and the reduced diameter section of the abutment end 62a. The diameter of the pivot axle 62 along its majority (i.e., the reduced diameter) is configured and arranged such that the pivot axle 62 freely rotatably supports the chain guide 26 to the movable member 22 in the fully inserted position. The shaft portion 62c is pivotally received within a portion of the chain guide 26 and a portion of the second housing 60 and is contiguously connected to the reduced diameter sections of the first and second ends 62a and 62b in the fully inserted (installed) position.

Optionally, the pivot axle 62 may each include a locking member 65 (only shown in phantom, broken lines in FIG. 7) substantially identical to the locking member 55 within the resilient fastening end 62b. Since such a locking member 65 (not shown in detail) would be substantially identical to the locking member 55, it will not be discussed and/or illustrated in detail herein. Rather, it will be apparent to those skilled in the art from this disclosure that the descriptions and illustrations of the locking member 55 also apply to the locking member 65, if used. In other words, it will be apparent to those skilled in the art from this disclosure that such a locking member 65 could be constructed as illustrated herein, or could be constructed with a bulbous end portion similar to the locking member 55. With such an arrangement, the slots 62e would be modified in a manner similar to the slots 54e to mate with such a bulbous portion.

The housing 60 basically includes a secondary mounting portion 68 and a second support portion 70, as best seen in FIG. 3. Preferably, the secondary mounting portion 68 and the second support portion 70 are integrally formed together as a one-piece, unitary member from a lightweight, rigid material such as a metallic material or any other material that is well known in the bicycle art. The secondary mounting portion 68 has the second axle 62 attached thereto in order to pivotally support the chain guide 26 for limited pivotal movement. Specifically, the secondary mounting portion 68 has a stepped bore having the second axle 62 received therein. The second support portion 70 is configured and arranged to have the linkage assembly 24 pivotally coupled thereto using two of the pivot pins 54 and two of the pivot sleeves 56 in accordance with the present invention.

Specifically, the second support portion 70 is provided with inner and outer through holes with two of the pivot sleeves 56 fixedly mounted therein in a manner substantially identical to the way the two pivot sleeves 56 are mounted to the first inner and outer link ends 50a and 52a. Likewise, two of the pivot pins 54 are mounted to the second inner and outer link ends 50b and 52b in a manner substantially identical to the manner in which the two pivot pins 54 are mounted to the flanges 40a and 40b of first support portion 40.

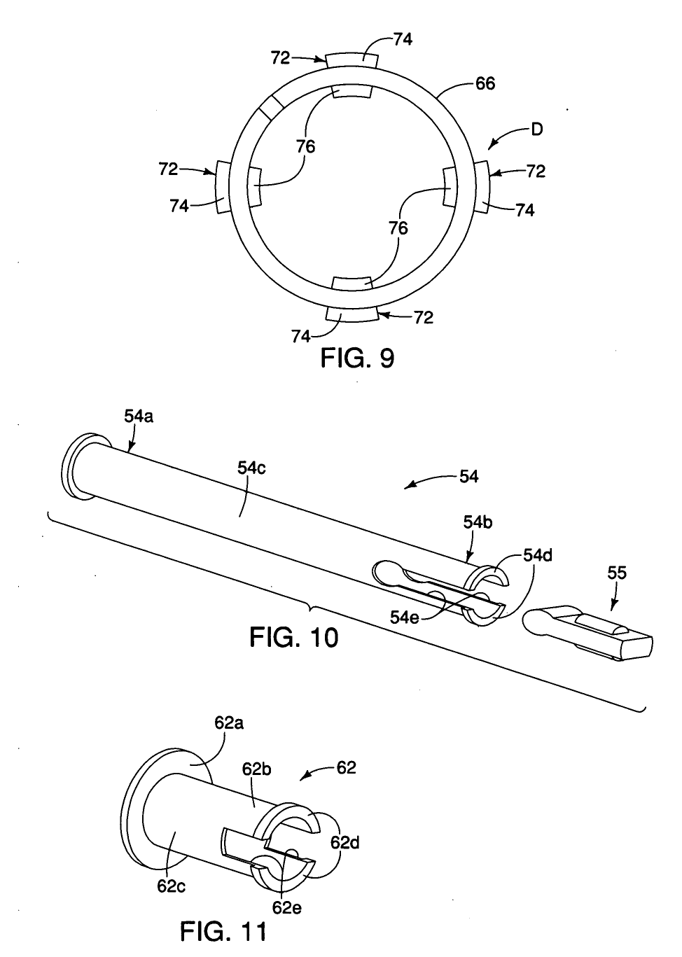

Referring now to FIGS. 7-9, the damping member D will now be explained in more detail. The damping member D is mounted with the second biasing member 66 within the second housing 60. In this embodiment, the damping member D includes a plurality of (i.e. four) separate damping elements 72 that are circumferentially spaced from each other about the rotation axis of the pivot axle 62. Each damping element 72 includes an elongated body portion 74 with a plurality of projections 76 extending therefrom. Preferably, the projections 76 and the body portion 74 of each damping element 72 are integrally formed together as a one-piece, unitary member from a non-metallic, elastic material such as a rubber material, an elastic plastic material or any other elastic material that is well known in the bicycle art.

The damping elements 72 are positioned at approximately ninety degree intervals about the torsion spring 66. The damping elements 72 are identical. The projections of 76 of each damping element 72 are preferably axially aligned with each other as viewed along the pivot axis Y. Each projection 76 is preferably arranged between an adjacent pair of coils of the torsion spring 66 such that the projection 76 contacts the adjacent pair of coils of the torsion spring 66. In the illustrated embodiment, each damping element 72 includes four projections 76 such that each adjacent pair of coils of the torsion spring 66 has one of the projections 76 disposed therebetween, as seen in FIGS. 7 and 8. The respective projections 76 of the four damping elements 72 can be considered respective sets of projections (e.g., first, second, third and fourth sets of projections 76). Each set of projections 76 are preferably axially aligned with each other.

In this embodiment, the body portion 74 of each damping element 72 is disposed radially outwardly of the torsion spring 66 such that the projections 76 extend radially inwardly from the respective body portions 74. In any case, the body portions 74 are disposed adjacent the torsion spring 66 such that the projections 76 extend radially therefrom. In other words, it will be apparent to those skilled in the art from this disclosure that the projections 76 can extend radially outward from a body portion, as discussed below with respect to another embodiment of the present invention.

Referring again to FIGS. 1-4 and 7, the chain guide 26 basically has a pair of guide plates 80a and 80b with a guide sprocket or pulley 82 rotatably coupled between the guide plates 80a and 80b and a tension sprocket or pulley 84 rotatably coupled between the guide plates 80a and 80b. The guide sprocket 82 and the tension sprocket 84 engage the chain C in a conventional manner. Accordingly, the additional parts of the chain guide 26 will not be discussed or illustrated in detail herein. The pulleys 82 and 84 engage with the driving chain C in an inverse-S-like manner, thereby guiding the chain C to a desired sprocket RS of the multistage sprocket assembly. The chain guide 26 is movably supported on the movable member 22 by the second axle 62. Specifically, the second pivot shaft 62 extends through a hole in the guide plate 80b and is then attached to the movable member 22, as explained above.

### Second Embodiment

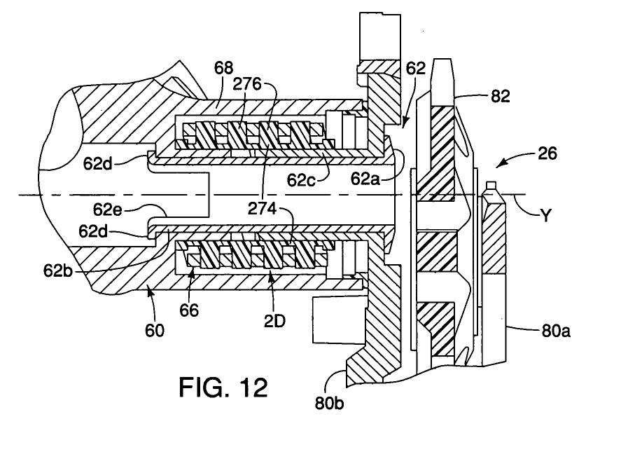

Referring now to FIGS. 12-14, a portion of the rear derailleur 12 having a modified damping member 2D mounted thereto in accordance with a second embodiment of the present invention will now be explained. The damping member 2D of this second embodiment is designed to be utilized on the rear derailleur 12 of the first embodiment, in place of the damping member D of the first embodiment.

In view of the similarity between the first and second embodiments, the parts of the second embodiment that are identical to the parts of the first embodiment will be given the same reference numerals as the parts of the first embodiment. Also, parts of this second embodiment that are functionally identical and/or substantially identical to parts of the first embodiment will be given the same reference numerals but with “200” added thereto. In any event, the descriptions of the parts of the second embodiment that are substantially identical to the parts of the first embodiment may be omitted for the sake of brevity. However, it will be apparent to those skilled in the art from this disclosure that the descriptions and illustrations of the first embodiment also apply to this second embodiment, except as discussed and/or illustrated herein.

The damping element 2D of this second embodiment is mounted with the second biasing member 66 within the second housing 60. In this embodiment, the damping member D includes a single elongated body portion 274 having a plurality of circumferentially spaced projections 276 extending therefrom to form a pair of damping elements 272 that are connected to each other by the body portion 274. Preferably, the projections 276 and the body portion 274 are integrally formed together as a one-piece, unitary member from a non-metallic, elastic material such as a rubber material, an elastic plastic material or any other elastic material that is well known in the bicycle art.

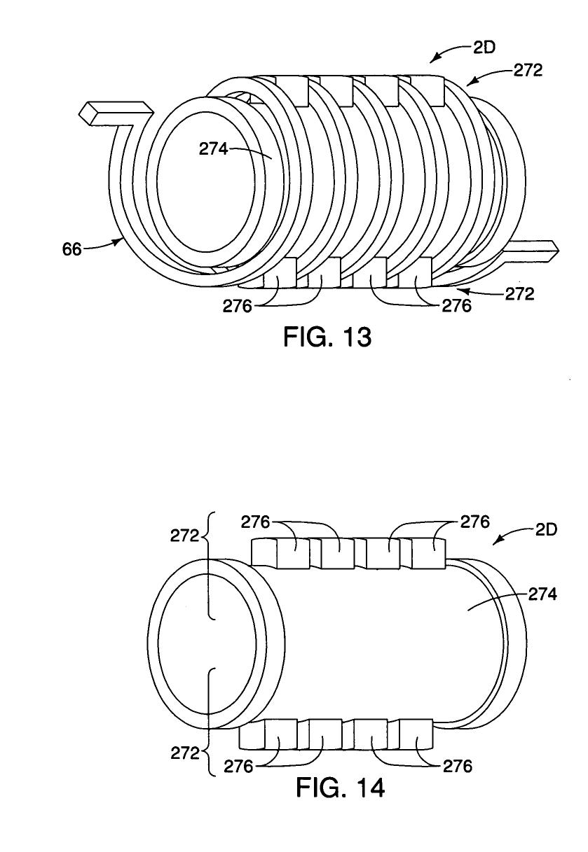

Preferably, there are two sets of projections of 276 that are axially aligned with each other as viewed along the pivot axis Y. Each projection 276 is preferably arranged between an adjacent pair of coils of the torsion spring 66 such that the projection 276 contacts the adjacent pair of coils of the torsion spring 66. In the illustrated embodiment, each set of axially aligned projections 276 includes four projections 76 such that each adjacent pair of coils of the torsion spring 66 has one of the projections 276 disposed therebetween, as seen in FIGS. 12 and 13. The two sets of projections can be considered first and second sets of projections 276 of first and second damping elements 272. The two sets of projections 276 are preferably circumferentially arranged about one-hundred-eighty degrees from each other.

In this embodiment, the body portion 274 has a tubular configuration, and is supported on the second pivot axle 62. Thus, the elongated body portion 274 is disposed radially inwardly of the torsion spring 66 such that the projections 276 extend radially outwardly from the body portion 274. In any case, the body portion 274 is disposed adjacent the torsion spring 66 such that the projections 276 extend radially therefrom.

Optionally, a damping member according to first and second embodiments may be disposed on the base member 20 solely or together with another damping member within the movable member, more specifically, it may be mounted with the first biasing member 36 within the base member 20 to restrict swing of the base member 20, which can also restricts chain bounce.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention as used in the normal riding position. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A bicycle rear derailleur comprising:
a base member configured to be attached to a bicycle frame;
a movable member including a support portion and a chain guide coupled to the support portion;
a linkage assembly coupled between the base member and the support portion to move the chain guide between a retracted position and an extended position;
a torsion spring disposed about a pivot member of at least one of the base member and the movable member; and
a damping member at least partially disposed between an adjacent pair of coils of the torsion spring.

2. The bicycle rear derailleur according to claim 1, wherein
the damping member includes a projection that normally contacts the adjacent pair of coils between which it is disposed.

3. The bicycle rear derailleur according to claim 2, wherein
the damping member is at least partially constructed of a non-metallic, elastic material.

4. The bicycle rear derailleur according to claim 1, wherein
the damping member includes a plurality of projections that are axially spaced from each other along an axis of the pivot member with each of the projections disposed between a respective adjacent pair of coils of the torsion spring.

5. The bicycle rear derailleur according to claim 4, wherein
the projections are aligned with each other as viewed along the axis.

6. The bicycle rear derailleur according to claim 4, wherein
each projection of the damping member normally contacts the respective adjacent pair of coils between which it is disposed.

7. The bicycle rear derailleur according to claim 5, wherein
the projections form a first set of projections, and the damping member further includes a second set of additional projections that are circumferentially spaced about the axis from the first set of projections.

8. The bicycle rear derailleur according to claim 7, wherein
each projection of the damping member normally contacts the respective adjacent pair of coils between which it is disposed.

9. The bicycle rear derailleur according to claim 4, wherein
the damping member includes an elongated body portion disposed radially outwardly of the torsion spring, and the projections extend radially inwardly from the elongated body portion.

10. The bicycle rear derailleur according to claim 1, wherein
the damping member includes a body portion disposed adjacent the torsion spring, and the projection extends radially from the body portion.

11. The bicycle rear derailleur according to claim 1, wherein
the movable member includes the pivot pin, and the chain guide is coupled to the movable member using the pivot pin.
